(19) United States
(12) Patent Application Publication
(10) Pub. No.: US 2015/0283745 A1
(43) Pub. Date: Oct. 8, 2015

(54) BOTTOM OF A CONTAINER THAT OPTIMIZES THE USE OF MATERIAL

(71) Applicant: WENCO S.A., Santiago (CL)

(72) Inventors: Pedro CHINNI VERGOTTINI, Santiago (CL); Francisco SAHLI COSTABAL, Santiago (CL)

(21) Appl. No.: 14/639,367

(22) Filed: Mar. 5, 2015

(30) Foreign Application Priority Data
Apr. 8, 2014 (CL) 0880-2014

(51) Int. Cl. B29C 45/72; B65D 43/00; B65D 85/34; B65D 6/16; B65D 6/00

(52) U.S. Cl. CPC B29C 45/7207; B65D 11/18; B65D 11/20; B65D 85/34; B65D 43/00; B29L 2031/7178

(57) ABSTRACT

The present invention comprises a bottom for a container for fruit and vegetable products that optimizes material usage by distributing the stresses to which it is subjected, thereby reducing the final weight of the container without losing strength, the bottom consists of a bottom frame attached to a bottom base, wherein said bottom base comprises ribs of variable height. Furthermore, the invention comprises a container for fruit and vegetable products which optimizes the use of material distributing the stresses to which it is subjected, thereby reducing the final weight of the associated container and its method of manufacture.

### FIELD OF THE INVENTION

The present invention consists of a bottom of a container that comprises a bottom frame attached to a bottom base formed by ribs of variable height, which optimizes the use of material for distributing stresses to which it is subjected, thereby achieving a reduction of the final weight of the bottom without strength losses.

Additionally, the present invention relates to a container which is made by collapsible side walls and by a bottom that comprises ribs of variable height, reducing the final weight of the container without strength losses.

Finally, the present invention relates to the container manufacturing process that incorporates the bottom of the present invention.

### BACKGROUND OF THE INVENTION

Currently, in the packaging industry there are several types of containers for storage and transportation of products, e.g., vegetable and fruit products during harvesting, these may be manufactured of different materials, shapes and sizes according to the requirements of the product to be stored and/or transported.

Nowadays, the containers used for storage and transportation of fruits during harvesting such grapes, cherries, blueberries among others, are preferably made of plastic material and mainly configured from a bottom in connection with lateral walls, forming an inner volume in which vegetable and fruits products to be stored and transported are placed.

It is also common in this type of containers that both the walls and the bottom of the box are formed from a structural framework that allow a significant reduction in the weight of the container, in this way achieving less manufacturing costs and an improved handling.

An example of the previously mentioned is disclosed by the CL patent application No. 0671-1990 which describes a multi box, squared based, whose walls and bottom have a regular rhomboidal framework, with four elongated hollows.

It is also common in this type of containers to have collapsible walls, which provides a significant increase in the space availability during transport and handling of said containers when they are not being used for storing products therein.

An example of this is disclosed by the CL patent application No. 0289-1998 which describes a folding box made of plastic, having sidewalls folding inwardly on the bottom wall of the box and which also provides elements of insertion that fit into projection insertions in said side walls.

A common problem in this type of containers is that as the collapsible sidewalls are not completely fixed, when such containers are filled with the products therein, the force exerted by these on the junction points of the side walls and bottom causes the container to deform that means a risk to the integrity of the container and especially to the products inside of the container.

Nowadays, solutions are available in the state of the art that seek to increase the stiffness of the structure as disclosed by the CL patent application No. 1075-2009, which describes a handle of one piece connectable to a harness, to be installed in a plastic box for the harvest of fruits and vegetables, comprising a metal bar of the type of wire to be inserted by pressure on each side of the box.

Meanwhile, the CL patent application No. 0187-2013, describes a plastic container for the storage and transport of fruit and vegetables, which has elements that reinforce the structure of the mentioned box or container allowing a better stress distribution, wherein said elements that reinforce the structure correspond tensor straps system consisting of a pair of thin plastic straps with terminals at their ends, which are arranged on two sides of the mentioned box.

While the above-mentioned inventions provide efficient solutions to prevent distortion and loss of rigidity of the container structure when filled with the products, there is yet another problem for this type of containers that has not been discussed or resolved by the current state of the art solutions.

The foregoing relates to the technical problems associated with the deformation of the bottom of the containers made of plastic material today and used for transport and storage of vegetable and fruit products.

In particular, when a container is filled, the bottom of this should be capable of withstanding, without breaking, the pressure exerted by the contents inside the container, which depends on the weight and type of products to be stored or transported in the container. In addition, such pressure may be often variable depending on the movement to which the container is subjected, where in many cases this corresponds to sudden movements caused by the operator or machinery responsible for transporting containers which causes a significant increase in efforts to which the bottom of the container is subject thereof.

In this context, it is important to consider the magnitude of the deformation of the bottom where an excessive deformation will cause the bottom of the upper box to press the content of the lower box, causing unacceptable damage or marks on the boxes.

In general, current containers that are manufactured by plastic injection are manufactured with a uniform bottom, either of the framework type, perforated or of plain bottom, where both the thickness and the height of the bottom are determined according to certain tolerance, so that the container can be used to transport products with different weights.

The strength produced by the products inside the container towards the bottom are distributed by the same towards the frame structure of the box where often reinforcing elements are arranged which correspond to plates or ribs that go through the bottom face of the container in a longitudinal, transversal or diagonal form.

While this type of manufacturing of a bottom container represents a reliable form, regarding the strength to withstand stresses generated by the variable content inside the container, there is often an excess of material in its manufacture which is unnecessary and in case it may be removed, significant benefits could be achieved in terms of depletion of the final weight of the container, reduction in manufacturing materials and consequently a reduction in manufacturing costs. In this regard, ordinary containers comprise a high percentage of its mass on the bottom, concentrating, in some cases, 41% of the mass of the container.

Therefore, the objective of the present invention is to provide a bottom container, for example for products, as fruit and vegetables, which optimizes the use of material for distributing the stresses to which it is subjected, thereby achieving a reduction of the final weight of the container without loss in strength.

### DESCRIPTION OF THE INVENTION

The present invention consists of a container bottom for fruits and vegetable products formed by a bottom frame which can totally or partially surround the bottom of the container, attached to a bottom base, which comprises ribs of variable height and where said variable height ribs consist of a body comprising an upper portion and a lower portion, the latter comprising a variable height.

In a preferred embodiment of the invention, the upper portion of the ribs of variable height is formed by a combination of sections of different geometry. Similarly, the bottom portion preferably comprises a rectangular body of variable height which base is always on the same plane.

According to the above, the variable height ribs have a “T” shape and the design of the lower portion has a variable height, in such a way that optimizes the distribution of the stresses produced by the products arranged inside the container, at the same time that allows to reduce the final weight of the bottom of the container compared with those containers used now.

Preferably, the variable height ribs have their maximum height at the ends or corners of the bottom frame, in which area the largest amount of strength caused by the weight of the products inside the container is required. Further and according to an embodiment of the invention, the bottom base may comprise areas not reinforced by variable height ribs in which the height of the rib is completely reduced to a minimum value. Therefore, the bottom of the container consists of a coat of variable height with areas of different geometry specially optimized to efficiently distribute the stresses to which it is subjected and reduce their weight lacking unnecessary material in its manufacture.

According to a preferred embodiment of the invention, the bottom base of the container consists of ribs of variable height arranged in a diagonal framework, circumscribed within the bottom framework, however, different designs and/or arrangements of the ribs of variable height can be used according to the needs of transportation or storage, as well as the type of fruits and vegetables products to be contained.

According to another aspect of the invention, a container for fruit and vegetable products which optimizes the use of material to distribute the stresses to which it is subjected, thereby reducing the final weight of the container without losing strength, which is formed at least by a bottom and side walls and the bottom of the container that has a bottom base which comprises ribs of variable height.

In a preferred embodiment of the invention, the container further comprises collapsible walls which are joined together by a junction system that comprises at least a closing device and a column fixed to one side of the faces, wherein said column is configured as a hollow cylindrical body, preferably of circular section or any other suitable shape, either elliptical, square, rectangular, triangular, etc., integrated into at least one of the closing means.

Additionally, the column of the junction system of the container comprises a base which is fixed to the bottom of the container, which comprises stacking means to facilitate latching with other containers.

Finally, the present invention also relates to the manufacturing procedure of a container which allows to optimize the use of material to distribute the stresses to which it is subjected, thereby reducing the final weight of the container without losing strength, which comprises the step of determining the shape of the bottom of the container according to the height of the ribs of variable height that form this base and to its own form, where the height, shape and distribution of the ribs of variable height obtained by the step of determining the shape of the bottom of the container depends on the size, material, type and shape of the container and the features comprised by the product (s) to be stored and/or transported.

### BRIEF DESCRIPTION OF THE DRAWINGS

The following figures are incorporated by reference and representation of a preferred embodiment of the invention, however other embodiments in accordance with the description which are not represented in these figures may be available.

FIGS. 1 to 3 illustrates examples of the types of bottoms of container according to the prior art of the invention.

FIG. 4 illustrates in detail a container bottom rib according to the prior art of the invention.

FIG. 5 illustrates a preferred embodiment of the bottom of the container as object of the present invention.

FIG. 6 illustrates in detail a container bottom rib, as object of the present invention.

FIG. 7 illustrates in detail an alternative embodiment of the container bottom rib, as object of the present invention.

FIG. 8 illustrates a superior plan view of the bottom of the container, as object of the present invention.

FIG. 9 illustrates the results of comparative tests of deformation carried out to the bottom of the container of the prior art regarding the present invention.

### DETAILED DESCRIPTION OF THE INVENTION

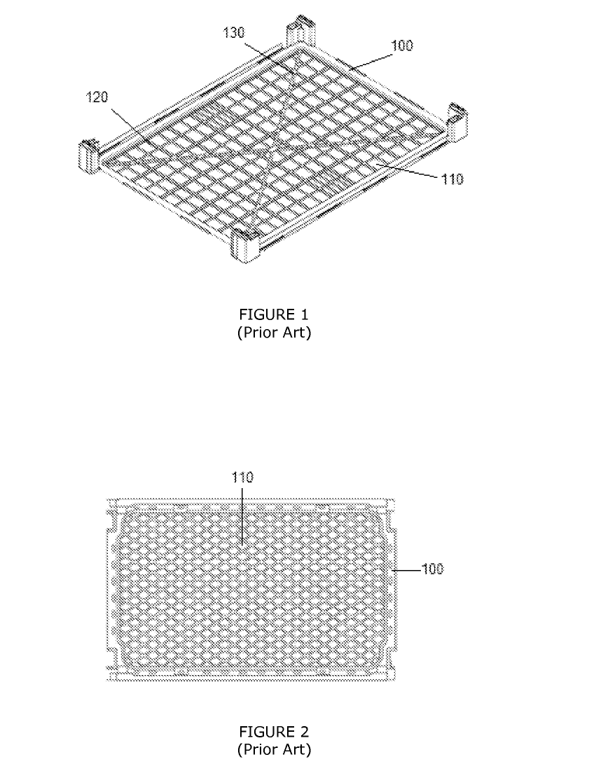

According to FIGS. 1 to 3, the bottoms of the container for fruits and vegetables products moulded by plastic injection are generally formed by a bottom frame (100) attached to a bottom base (110), wherein according to FIG. 1, this bottom base (110) may be a framework formed by plastic ribs (120) orthogonal to the bottom edges of the frame (100), which may further include reinforcing ribs (130) intersecting diagonally the bottom frame for providing greater strength to the structure. Alternatively and as seen in FIG. 2, the bottom base (110) can also be formed from a diagonal framework in which rhomboid hollows may be formed.

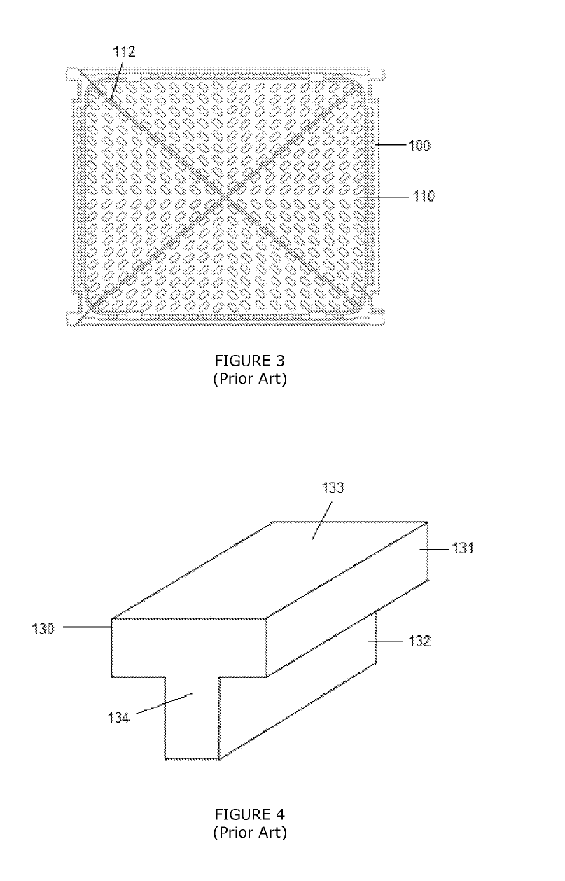

According to FIG. 3, the bottom base (110) can also consist of a rigid perforated sheet surface, optionally including reinforcing ribs (130) supported on the lower face and diagonally crossing or in some other direction of the bottom frame.

The design and type of the bottom base used in the containers for fruit and vegetable products is nowadays subjected to the features of shape, size and weight of the products to be stored, being evident that for smaller products, a smaller framework space will be required in order that those products do not pass through the container walls. Similarly, heavier products require to be transported in containers with bottoms that include reinforcing ribs or bottom bases of the type of rigid surface.

According to FIG. 4, a reinforcing rib (130) as those used in the containers of fruit and vegetable products of the prior art, which are generally comprised of a structure in a “T” form comprising a horizontal rectangular portion (131) and a vertical rectangular portion (132), wherein the top face (133) of the horizontal rectangular portion (131) is faced to the inside of the container as part of the surface where the products stored in the container are supported as shown in FIG. 1.

Similarly, the reinforcing rib (130) is attached to the frame base bottom (110) by end means (134) in a way that the force caused by the weight of the products stored inside the container is transmitted from any point of the reinforcing rib (130) towards the base frame, and due to the greater contact surface area provided between the frame and said ends (134) given by the vertical rectangular portion (132), it will be avoided that the horizontal rectangular portion (131) be bulged offering more resistance to traction, bending and twisting of the container bottom.

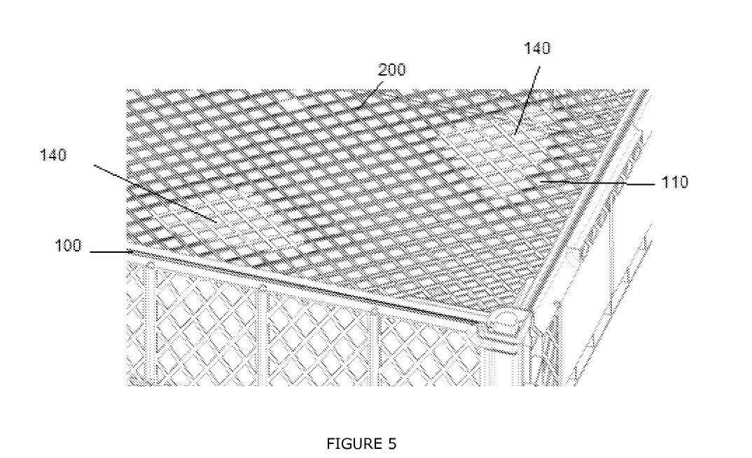

According to FIG. 5, the present invention consists of a container bottom for fruits and vegetable products comprised of a bottom frame (100) attached to a bottom base (110), where in a preferred embodiment of the invention, said bottom base (110) consists of a diagonal framework comprised of variable height ribs (200). According to the present invention the bottom frame (100) can completely or partially surround the container.

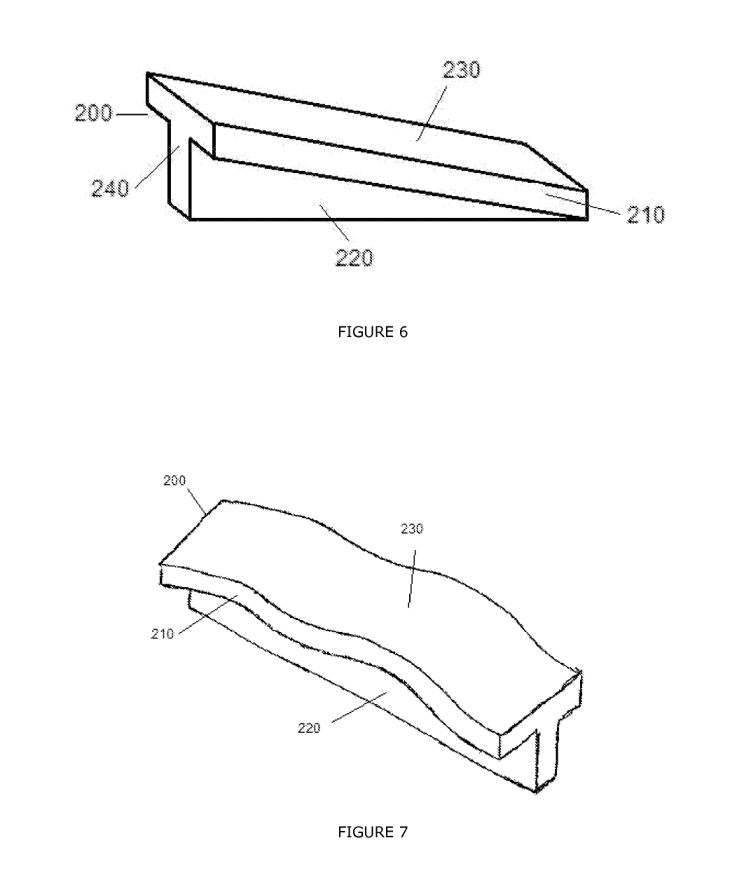

Variable height ribs of the present invention, and according to that illustrated in FIG. 6, consists of a body comprising an upper portion and a lower portion, wherein said lower portion which is located outward to the container has a variable height in the extension of the rib, wherein the of said lower portion of all the ribs of the bottom of the container are in the same plane. Meanwhile, the upper portion is configured as a body which is adapted to the variable height of the lower portion.

In the embodiment illustrated by FIG. 6 the rib of variable height (20) has a “T” shape, being formed by an upper portion (210) and a lower portion (220). The upper portion (210) of rectangular section with an upper face (230) and uniform thickness, is configured adapting to the height of the lower portion (220) that has a rectangular section of variable height and uniform thickness. In this sense, the variable height rib (200) is configured in such a way that in the ends (240) of the nerve which are in contact with the frame base, the lower portion (220) reaches its maximum height, which in a preferred embodiment becomes progressively decreased toward the central part of the rib of the bottom container, where the mentioned bottom portion (220) has its minimum height, where along the entire length of the rib of variable height (220) the base of the lower portion (220) is located on the same plane.

Notwithstanding the above, the upper and lower portions may also be of a trapezoidal or oval form or any other type of form, so that its geometry is not a limitation for the present invention.

FIG. 7 illustrates another example of the variable height rib (200), wherein the upper portion (210) is formed by a combination of sections to be adaptable to the variable height of the lower portion (220) setting an upper face (230) with curves, wherein said upper portion may be formed by a rectangular, trapezoidal or a combination of any type of section to be adaptable to the variable height of the lower portion (220).

According to the above and once more, in reference to FIG. 5, the bottom of the container is formed of a bottom base (100) formed by a framework of variable height ribs (200), providing a bottom of variable height, in which according to the illustrated example, the bottom base (100) can comprise unreinforced areas (130) in which the rib height is completely reduced to a minimum value, wherein the base of the lower portion is in the same plane.

The above configuration allows an important depletion in the final weight of the containers in which the background of the present invention is used, which is essentially achieved due to the depletion of material that can be obtained through the ribs of variable height, while achieving at the same time a balance and transmission of optimized efforts.

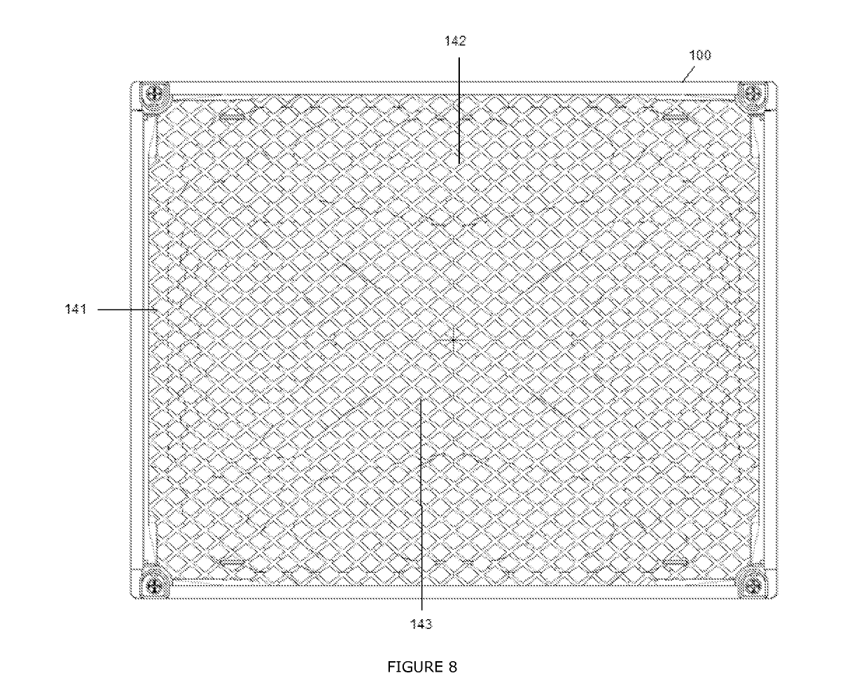

In the top plan view of the bottom of the container bottom shown in FIG. 8, a bottom base is shown, in which variable areas (141, 142, 143) may be observed, that represent changes in the height of the ribs of the container or changes in form. Thus, the areas closer to the bottom frame (100) have a greater height than the ones in the central area (143).

Similarly, an area may also contain differences in height between the ribs of variable height that form the area, as for example the area (142) may have a spherical shape and thus the ribs located in the central portion of said area could have a higher height than those arranged in the peripheral portions, and at the same time, the area (141) could be formed by ribs whose lower portion changes in height while maintaining a uniform base in the same plane.

Therefore, the different configuration of areas with different shapes and variables heights cause that the upper face (230) of the bottom of the container looks like a coat whose irregular geometry and design will depend exclusively to the efforts to which the container is subjected, associated to the weight, size and shape of the content to be stored, which can be determined for example by results obtained by test of modeling and computational simulation.

The fact that the greater height of the ribs is concentrated on the point of contact with the frame in the ends of the base, is related to that such points are receiving the maximum strength of traction, bending and cutoff generated by the weight of the products inside the container, thus being well distributed the efforts of the bottom towards said points through the ribs that go through the frame, it is possible to disregard the material of the lower portion of the rib of variable height without losing resistance.

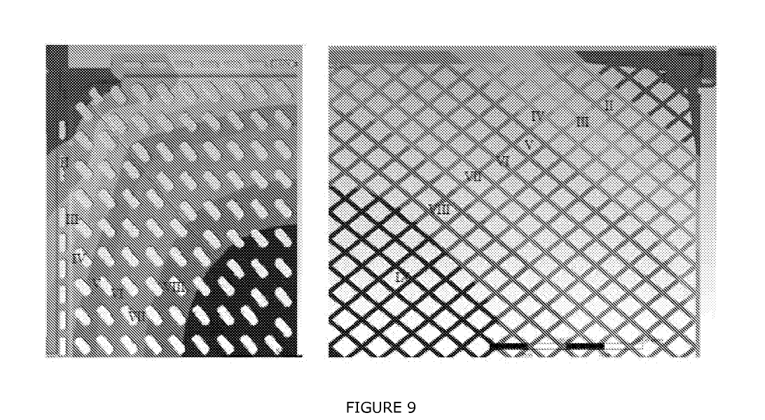

A test was performed to measure the directional deformation in the Z axis of the bottom of the container of the present invention in relation to one of the types of the bottoms used in the prior art which is illustrated in FIG. 9.

The bottoms of the containers shown are marked in areas, where area 1 corresponds to that area closest to the vertex of the frame to which the bottom is attached and the area VI corresponds to the area closest to the center of the bottom of the container.

The table below shows the results of the test applied to the bottom of the box to be compared.

| | Deformation background | Deformation background of |
|---|---|---|
| Zone | prior art [mm] | the invention[mm] |
| Max | 0.020132 | 0.035269 |
| I | | |
| | −1.7996 | −1.7563 |
| II | | |
| | −3.6193 | −3.5478 |
| III | | |
| | −5.4389 | −5.3394 |
| IV | | |
| | −7.2586 | −7.1309 |
| V | | |
| | −9.0783 | −8.9225 |
| VI | | |
| | −10.898 | −10.714 |
| VII | | |
| | −12.718 | −12.506 |
| VIII | | |
| | −14.537 | −14.297 |
| IX | | |
| Min | −16.357 | −16.089 |

From the results of the trial it was found that the deformation of the bottom of the container bottom of the prior art was 16,357 mm versus the background of the present invention was 16,089 mm, showing even a reduction of almost 2% in the bottom deformation according to the implementation of the bottom of the invention. In addition, implementation of the bottom of the invention resulted in a weight difference of 35.89 gr in the bottom, which represents a depletion of 24.63% from the weight of the bottom of the container of the prior art.

This weight reduction is of great advantage from the point of view of production because it reduces the use of materials for manufacturing, thereby also decreasing manufacturing costs in addition to improvements associated with the handling of products.

Despite the above, the present invention is not limited only to the type of bottom base tested, i.e., using a diagonal framework and may also be formed by a framework of ribs with variable height orthogonal to the bottom frame or a rigid perforated base and reinforced with ribs of variable height according to containers currently used.

Thus, the present invention also relates to a fruit and vegetable product container which comprises a bottom formed by ribs of variable height according to the embodiments described in the preceding paragraphs, allowing to optimize the use of material to distribute the stresses to which the container is subjected, thereby achieving a significant reduction of the weight thereof and without loss in strength.

In a preferred embodiment of the invention the fruit and vegetable products container has collapsible walls, which are joined together by a junction system located at the free ends of said walls, comprising at least one closing device, preferably of the clip type, having at least a pair of closing means, a male closing means and another female closing means, wherein said closure means joins at least two structures or to two adjacent sides of a container for fruit and vegetable products, preferably the side faces being fixed to them.

According to an embodiment of the invention, the junction system comprises a column fixed to one of said structures or faces, wherein said column is configured as a hollow cylindrical body, preferably of circular section, which in turn is integrated to at least one of the closing means. Preferably, the column is configured as a straight hollow cylinder whose cross section is a circle. In alternative embodiments the cross section of the cylindrical body can also be oval, polygonal, with open or closed “U” forms, or any shape which allows to be configured as a hollow cylindrical body.

Additionally, the column comprises a base which is fixed to the bottom of the container, so that when the side faces joining together the column are mounted on said base forming a continuous structure together with the junction of the side faces.

According to a preferred embodiment of the invention, the base of the column also comprises means of stacking which latch with the stacking means of the column that another container has at the upper portion, in order that a first structure or container for fruit and vegetable products can safely be stacked over a second structure or container.

Those skilled in the subject matter will understand that the container for fruit and vegetable products with variable height bottoms of the present invention is not limited to a certain size, shape or only to the type of collapsible walls, being also able to be of the type formed by fixed side walls comprising openings or only solid walls and also include a cap or not, etc.

The present invention also relates to the manufacturing process of the bottom of the containers, in particular a collapsible container incorporating such bottom, being relevant to indicate that said procedure consists of injection molding, which comprises employing a mold with the shape of the container and injecting material, preferably plastic into said mold. In addition, the manufacturing process allows the manufacture of a container with a bottom that optimizes the use of the material to distribute the stresses to which it is subjected, thereby achieving a reduction of the final weight of the container without loss in strength.

In general terms the injection procedure considers the following steps:

Injecting plastic into a closed mold;
Cooling the manufactured structure into the mold;
Opening the mold for extracting the manufactured structure; and
Closing the mold to start a new manufacturing cycle.

In this context, the present invention includes an additional step to the manufacturing processes of the prior art that consists in determining the shape of the bottom of the container based on the height of the ribs that form said base and its own form, which allows to obtain a bottom container design that is optimally adapted to the needs of effort to which it is subjected, while at the same time minimizing the weight of the bottom and consequently the final weight of the container. In this context, shape or geometry determined to the bottom of the container is used for the manufacture of molds that form the container and in particular, the bottom of it, so that the features possessed by the mold will be printed on all containers made with such molds.

The step of determining the shape of the bottom of the container based on the height, shape and distribution of ribs of variable height depend exclusively on the content itself, since the size, shape and weight of the products to be stored within the container are those that ultimately affect the efforts to which the structure is subjected. Therefore, the bottom of the container must be able to support them, so the type of product is crucial to the design of the bottom so that efforts be optimally distributed through the ribs of variable to the bottom frame.

In a preferred embodiment of the invention, the step of determining the shape of the bottom of the container is performed by a computer program which yields the optimum geometry of the bottom of the container according to the size, material, type and shape of the container to use as well as based on the characteristic of the products to be stored and/or transported.

According to the step aforementioned it is possible to obtain infinite configurations for the bottom of the container, resulting in a coat inside the frame bottom, formed by the ribs of variable height that form a structure of variable geometry which allows distributing stresses by using less material and without loss of strength, which finally results in a significant reduction in weight and manufacturing costs.

Those skilled in the art will understand that involved optimal design of the container bottom is not limited to a single technique of the computational type, but also other methods, such as trial and error may also be applied among others.

1. Bottom of a container for vegetable and fruits products that optimizes the use of material to distribute the stresses to which it is subjected, thereby reducing the final weight of the container without losing strength, being said bottom formed by a bottom frame attached to a bottom base, wherein said bottom base comprises ribs of variable height.

2. Bottom of a container according to claim 1, wherein the ribs of variable height consist of a body comprising an upper portion and a lower portion, wherein said lower portion has a variable height.

3. Bottom of a container according to claim 2, wherein the upper portion is a body of constant thickness with an upper face adapted to the variable height of the lower portion that is a rectangular body with a base arranged in a single plane.

4. Bottom of a container according to claim 2, wherein the upper portion is formed by a combination of sections of different geometry and height according to the variation in height of the lower portion.

5. Bottom of a container according to claim 1, wherein the ribs of variable height have a “T” shape.

6. Bottom of a container according to claim 1, wherein the ribs of variable height have its maximum height at the ends.

7. Bottom of a container according to claim 1, wherein the bottom base comprises non-reinforced areas in which the rib height is reduced to a minimum value, said base being arranged in the same plane.

8. Bottom of a container according to claim 1, wherein the ribs of variable height are distributed on the bottom forming an upper face of variable height with different geometry areas.

9. Bottom of a container according to claim 1, wherein the bottom base is formed by the ribs of variable height arranged in a diagonal framework, circumscribed within the bottom frame.

10. Bottom of a container according to claim 1, wherein the bottom base is formed by ribs of variable height arranged orthogonally to the bottom frame.

11. Bottom of a container according to claim 1, wherein the bottom base consists of a rigid base punctured reinforced with the ribs of variable height.

12. Container for fruit and vegetable products that optimizes the use of material to distribute the stresses to which it is subjected, thereby reducing the final weight of the container without losing strength, which is formed at least of a bottom and sidewalls, wherein the container bottom is provided with a bottom base which comprises ribs of variable height.

13. Container according to claim 12, wherein the same is provided with collapsible walls which are joined together by a bonding system comprising at least a closing device.

14. Container according to claim 13, wherein said closing device corresponds to the dip type, comprising at least a pair of closing means, wherein said closing means connect at least two structures or two adjacent faces of the container.

15. Container according to claim 14, wherein the bonding system of the container comprises a fixed column to one of the structures or faces, wherein the mentioned column is configured as a hollow cylindrical body, composed of at least one of the closure means.

16. Container according to claim 15, wherein the column has preferably a circular section and may be elliptical, square, rectangular, triangular or any suitable shape.

17. Container according to claim 15, wherein the column comprises a base which is fixed to the bottom of the container.

18. Container according to claim 17, wherein the base of the column comprises stacking means.

19. Container according to claim 12, wherein the side walls are fixed.

20. Container according to claim 12, wherein the container consists of a structure comprising openings.

21. Container according to claim 12, wherein the container consists of a solid structure.

22. Container according to claim 12, wherein the container further comprising a lid.

23. Method of manufacturing a container, which optimizes the use of material for distributing stresses to which it is subjected, thereby reducing the final weight of the container without losing resistance, comprising the steps of:
defining the shape of the bottom of the container according to the height of the ribs of variable height that forms the mentioned base and its own form, wherein said form will be used to manufacture a mold of the container;
Injecting plastic material into the dosed mold, wherein said mold comprises the form of ribs of variable height determined for the bottom of the container;
Cooling the structure manufactured in the inside of the mold by heat transfer from said structure into the mold;
Opening the mold for the extraction of the manufactured structure; and
Closing the mold to start a new manufacturing cycle;
wherein the step of determining the shape of the bottom of the container allows to optimize the use of the material to distribute the stresses to which the container is subjected.

24. Method of manufacturing a container according to claim 23, wherein the height, shape and distribution of the ribs of variable height obtained by the step of determining the shape of the bottom of the container depends on the size, material, type and shape of the container and the features of the product(s) to store and/or transport.

25. Method of manufacturing a container according to claim 23, wherein the step of determining the shape of the bottom of the container is performed by a computer program that yields the optimum geometry of the bottom of container.

26. Method of manufacturing a container according to claim 23, wherein the step of determining the shape of the bottom of the container is carried out by trial and error techniques.
